(19) United States
(12) Patent Application Publication
(10) Pub. No.: US 2026/0151286 A1
(43) Pub. Date: Jun. 4, 2026

(54) APPARATUS AND METHOD USING A SPRING-POWERED KNEE EXOSKELETON FOR GAIT ASSISTANCE

(71) Applicant: UNIVERSITY OF FLORIDA RESEARCH FOUNDATION, INCORPORATED, Gainesville, FL (US)

(72) Inventors: Walter Sebastian BARRUTIA, Gainesville, FL (US); Daniel Perry FERRIS, Gainesville, FL (US)

(21) Appl. No.: 19/123,910

(22) PCT Filed: Oct. 23, 2023
(86) PCT No.: PCT/US2023/035692

§ 371 Date: Apr. 24, 2025

Related U.S. Application Data
(60) Provisional application No. 63/421,694, filed on Nov. 2, 2022.

(51) Int. Cl. A61H 3/00; A61H 1/02

(52) U.S. Cl. CPC A61H 3/00; A61H 1/024; A61H 2003/007; A61H 2201/1253; A61H 2201/149; A61H 2201/1642

(57) ABSTRACT

An apparatus and method is provided using a spring-powered knee exoskeleton for gait assistance. The apparatus includes a first bar attached to a thigh and a second bar attached to a shank. The apparatus also includes a spring attached to the first bar and connected to a spring pulley. A sprocket is configured to rotate based on variation of an angle between the first bar and the second bar. A clutch is configured to rotatably connect the sprocket with the spring pulley during a stance movement phase such that the spring imparts an assistive extensor moment about the knee joint. The clutch is further configured to rotatably disconnect the sprocket with the spring pulley during a swing movement phase such that the assistive extensor moment is not imparted. The apparatus excludes electrical components that transmit or receive electrical signals and/or has a total weight of less than about 3 kg.

### CROSS-REFERENCE TO RELATED APPLICATIONS

This application claims benefit of U.S. Provisional Application No. 63/421,694, filed Nov. 2, 2022, under 35 U.S.C. § 119(e).

### STATEMENT OF GOVERNMENTAL INTEREST

This invention was made with government support under Grant No. T32 HD043730 awarded by the National Institutes of Health. The government has certain rights in the invention.

### BACKGROUND

Knee exoskeletons have been developed to provide assistance to the knee joint during walking. Such knee exoskeletons are typically used by patients who have suffered an injury or a medical condition that affects the patient's ability to move one or more joints. Such patients routinely undergo physical rehabilitation, in an effort to recover mobility and control of the knee joint. In one form of conventional knee exoskeletons, one or more electrical components are employed such as a power source to provide electrical current; an electrical motor to impart torque about the knee joint after receiving electrical current from the power source and various electrical sensors to detect when the knee is in different movement phases of the gait cycle in order to provide the appropriate assistive torque for the detected movement phase. Due to the electrical components of these conventional knee exoskeletons, they tend to be bulky (e.g. over 5 kilograms (kg) per leg).

Additionally, other conventional knee exoskeletons are known which provide an assistive moment during some movement phases (e.g. stance movement phase) but lock the knee in other movement phases (e.g. swing movement phase) of the gait cycle.

### SUMMARY

It is here recognized that conventional knee exoskeletons for patients with impaired knee joints are deficient, since they feature electrical components that are heavy and bulky and increase metabolic demand on the patient. Additionally, these conventional knee exoskeletons lock the knee joint during some movement phases (e.g. swing movement phase) which inhibits free movement of the knee joint. To overcome these noted drawbacks of conventional knee exoskeletons, the inventors of the present invention developed an improved knee exoskeleton which does not employ electrical components and thus is much lighter and consequently imposes less metabolic demand on the patient. Additionally, this improved knee exoskeleton is more cost efficient and less complex than the conventional knee exoskeletons. Yet further, the improved knee exoskeleton does not lock the knee joint during some movement phases of the gait cycle and thus permits free movement of the knee joint during those movement phases (e.g. swing movement phase) when no assistive moment is necessary.

In a first set of embodiments, an apparatus is provided using a spring-powered knee exoskeleton for gait assistance. The apparatus includes a first bar configured to be attached to a thigh above a knee joint of a subject. The apparatus also includes a second bar configured to be attached to a shank below the knee joint and pivotally coupled to the first bar adjacent the knee joint. The apparatus also includes a spring attached to the first bar and connected to a spring pulley. The apparatus also includes a sprocket configured to rotate based on variation of an angle between the first bar and the second bar during a gait cycle of the subject. The apparatus also includes a clutch configured to rotatably connect the sprocket with the spring pulley during a stance movement phase of the gait cycle such that rotation of the sprocket causes rotation of the spring pulley and elongation of the spring to impart an assistive extensor moment about the knee joint. The clutch is further configured to rotatably disconnect the sprocket from the spring pulley during a swing movement phase of the gait cycle such that rotation of the sprocket does not cause rotation of the spring pulley and elongation of the spring. Additionally, the apparatus excludes electrical components that transmit or receive electrical signals and/or has a total weight of less than about 3 kg.

In a second set of embodiments, one or more components of the apparatus in the first set of embodiments are 3D printed with one of carbon fiber, nylon and Kevlar material.

In a third set of embodiments, a method is presented using a spring-powered knee exoskeleton for gait assistance. The method uses one or more components of the apparatus from the first set of embodiments.

In a fourth set of embodiments, a method is presented for 3D printing one or more components of the apparatus from the first set of embodiments.

Still other aspects, features, and advantages of the invention are readily apparent from the following detailed description, simply by illustrating a number of particular embodiments and implementations, including the best mode(s) contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an image that illustrates an example of a gait cycle including a plurality of movement phases, according to an embodiment;

FIG. 1B is a graph that illustrates an example of curves indicating the moment imparted about the knee joint during the stance movement phase and the swing movement phase of the gait cycle, according to an embodiment;

FIG. 2A is an image that illustrates an example of an apparatus for using a spring-powered knee exoskeleton for gait assistance, according to an embodiment;

FIG. 2B is a block diagram that illustrates an example of an apparatus for using a spring-powered knee exoskeleton for gait assistance, according to an embodiment;

FIG. 2C is an image that illustrates an example of a subject to wear the apparatus of FIG. 2B with an angle formed between the thigh and shank during the gait cycle, according to an embodiment;

FIG. 3A is an image that illustrates an example of a front view of an apparatus for using a spring-powered knee exoskeleton for gait assistance, according to an embodiment;

FIG. 3B is an image that illustrates an example of an end view of the apparatus of FIG. 3A, according to an embodiment;

FIG. 3C is an image that illustrates an example of a side perspective view of the clutch of the apparatus of FIG. 3A, according to an embodiment;

FIG. 3D is an image that illustrates an example of an end view of the clutch of FIG. 3C, according to an embodiment;

FIG. 4A is an image that illustrates an example of a rear perspective view of a shoe lever of the apparatus of FIG. 3A, according to an embodiment;

FIG. 4B is an image that illustrates an example of a top perspective view of the shoe lever of FIG. 4A, according to an embodiment;

FIG. 4C is an image that illustrates an example of a side view of the shoe lever of FIG. 4A, according to an embodiment;

FIG. 5A is an image that illustrates an example of an end view of the apparatus of FIG. 3A worn on thigh and shank of a subject, according to an embodiment;

FIG. 5B is an image that illustrates an example of a front perspective view of a knee sprocket and a clutch sprocket of the apparatus of FIG. 5A worn on the subject, according to an embodiment;

FIG. 5C is an image that illustrates an example of a rear perspective view of the shoe lever of the apparatus of FIG. 5A worn on the subject, according to an embodiment;

FIG. 5D is an image that illustrates an example of a front view of the apparatus of FIG. 5A worn on the subject, according to an embodiment;

FIG. 5E is an image that illustrates an example of a front view of the clutch lever of the apparatus of FIG. 5A, according to an embodiment;

FIG. 5F is an image that illustrates an example of a side perspective view of the clutch lever of the apparatus of FIG. 5A, according to an embodiment;

FIG. 6A is an image that illustrates an example of a front view of an apparatus for using a spring-powered knee exoskeleton for gait assistance, according to an embodiment;

FIG. 6B is an image that illustrates an example of an end view of the apparatus of FIG. 6A, according to an embodiment;

FIG. 6C is an image that illustrates an example of a side perspective view of the clutch of the apparatus of FIG. 6A, according to an embodiment;

FIG. 6D is an image that illustrates an example of an end view of the clutch of FIG. 6C, according to an embodiment;

FIG. 6E is an image that illustrates an example of an exploded view of the apparatus of FIG. 6A, according to an embodiment;

FIG. 6F is an image that illustrates an example of an exploded view of the clutch of the apparatus of FIG. 6A, according to an embodiment;

FIG. 7 is an image that illustrates an example of a rear perspective view of a shoe lever of the apparatus of FIG. 6A, according to an embodiment;

FIG. 8A is an image that illustrates an example of a front view of the apparatus of FIG. 6A worn on thigh and shank of a subject, according to an embodiment;

FIG. 8B is an image that illustrates an example of a side view of the apparatus of FIG. 6A worn on thigh and shank of a subject, according to an embodiment;

FIG. 8C is an image that illustrates an example of a rear perspective view of the shoe lever of the apparatus of FIG. 6A worn on the subject, according to an embodiment;

FIG. 8D is an image that illustrates an example of a front view of the apparatus of FIG. 5A worn on the subject as they walk, according to an embodiment;

FIG. 9 is a flow diagram that illustrates an example of a method for using a spring-powered knee exoskeleton for gait assistance, according to an embodiment;

FIG. 10 is an image illustrating an example of a phantom leg wearing the apparatus of FIG. 6A for purposes of testing the apparatus, according to an embodiment;

FIGS. 11A through 11C are graphs illustrating an example of one or more curves that are used to measure the performance of the apparatus for using a spring-powered knee exoskeleton for gait assistance, according to an embodiment; and

FIG. 12 is an image illustrating an example of a 3D printer used to form one or more components of the apparatus of FIG. 3A, according to an embodiment.

### DETAILED DESCRIPTION

A method and apparatus are described for using a spring-powered exoskeleton for gait assistance of an impaired joint. For purposes of the following description, an impaired joint is defined as any joint of the human body experiencing impaired movement, due to an injury or medical condition sustained by the patient. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of using a spring-powered exoskeleton for adaptive assistance over a plurality of movement phases during training of an impaired joint, such as a knee joint, an ankle joint or a hip joint. The embodiments of the invention are also described below in the context of a spring-powered exoskeleton which does not employ electrical components and is exclusively made from mechanical components that neither transmit nor receive electrical signals. In yet further embodiments of the invention the spring-powered exoskeleton is light weight (e.g. less than 2 kg for each leg). However, the invention is not limited to this context. In other embodiments, the spring-powered exoskeleton is used to provide assistance over a plurality of movement phases during training or strengthening of a healthy joint.

For purposes of this description, “electrical component” means a component that transmits or receives electrical signals while performing its function (e.g., a power supply, an electrical motor, an electrical controller, an electrical sensor that transmits or receives voltage or current to communicate a sensed measurement, etc.). For purposes of this description, “mechanical component” means a component that does not transmit or receive electrical signals while performing its function (e.g. spring, rotating sprocket, non-electrical cable, mechanical clutch, etc.)

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4. As used herein a value of about a certain number is understood to mean either a factor of two with the certain number or an implied precision given by a least significant digit for the certain number.

When a patient suffers an injury or medical condition that affects one or more of their joints, the patient's ability to move and control the joint is impaired. For example, the patient may not be able to move the joint at a torque that was previously achievable prior to the injury or medical condition. Additionally, the patient may not be able to move the joint through a range of motion, at a speed or at an orientation that was previously achievable prior to the injury or medical condition. According to various embodiments, an exoskeleton is provided which provides an assistive extensor moment about the joint (e.g. knee) during those movement phases of high joint stiffness while imparting no or minimal extensor moment about the joint during those movement phases of low joint stiffness. This exoskeleton advantageously imparts an extensor moment about the joint only for those movement phases where high joint stiffness is required for proper movement of the joint.

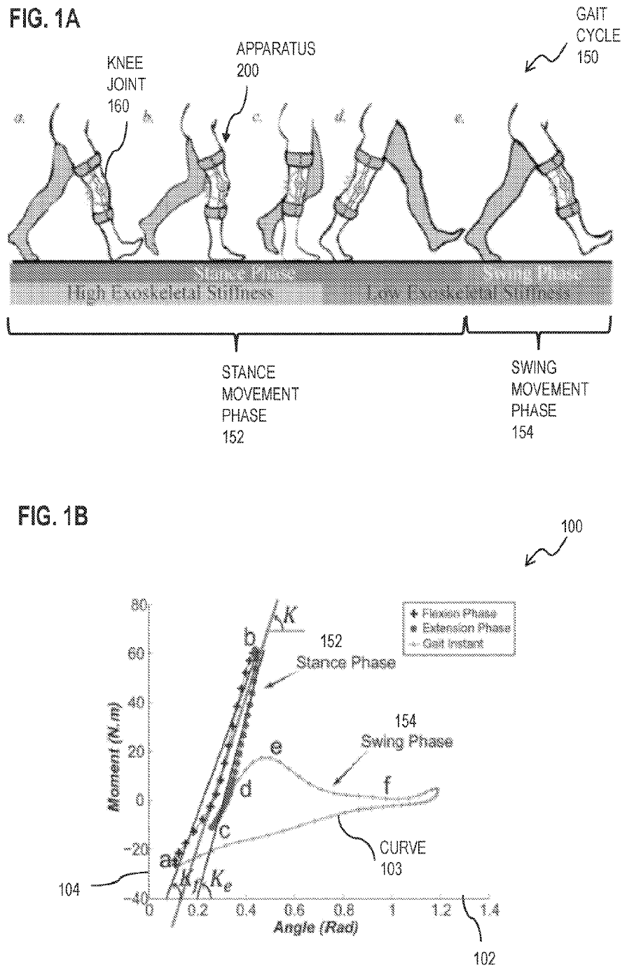

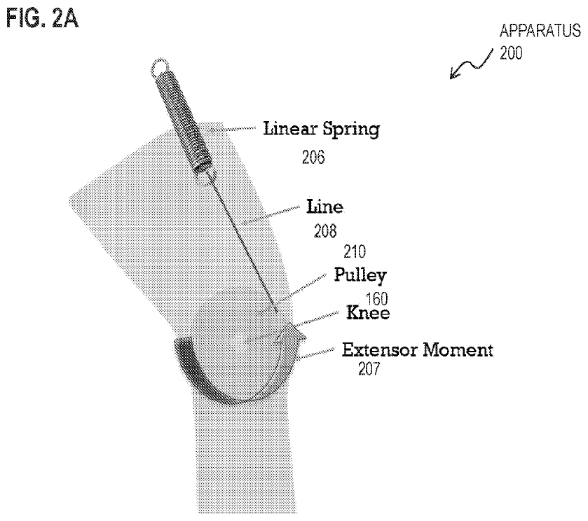

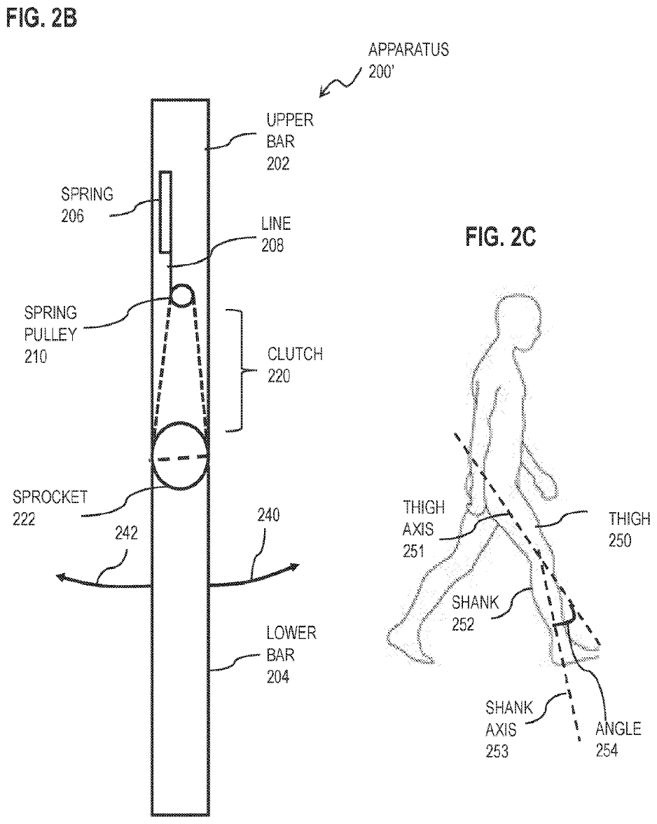

When a joint is moved through a range of motion, this range of motion includes a plurality of movement phases. FIG. 1A is an image that illustrates an example of a gait cycle 150 including a plurality of movement phases a-e of a knee joint 160, according to an embodiment. The movement phases a-d are herein referred to as a stance movement phase 152 and the movement phase e is herein referred to as a swing movement phase 154. In one embodiment, phase a is a “heel strike” phase when the heel initially makes contact with the ground; phases b and c are respectively known as “weight acceptance” and “terminal” phases when the foot is flat on the ground and phase d is a “toe off” phase when the toe leaves contact with the ground. In another embodiment, phase e is the swing movement phase 154 and begins after phase d when the toe leaves the ground and ends at phase a when the heel makes contact with the ground. FIG. 2A also shows an apparatus 200 worn by the subject on the knee joint 160 during the gait cycle 150 and which advantageously imparts an assistive extensor moment during some of the movement phases, as discussed herein.

As a healthy joint (e.g. knee) moves through the different movement phases of the gait cycle 150, a different moment is provided about the joint and thus the joint undergoes different levels of angular stiffness depending on the movement phase. FIG. 1B is a graph 100 that illustrates an example of a curve indicating the moment imparted about the knee joint during the stance movement phase and the swing movement phase of the gait cycle, according to an embodiment. The horizontal axis 102 is a knee angle, defined as an angle between the thigh and the shank, in units of radians (rad). The vertical axis 104 is the moment imparted about the knee joint, in units of Newton*meters (N·m). A curve 103 is shown in FIG. 1B that indicates the moment about a healthy knee joint 160 at different movement phases a-e of the gait cycle 150. Note that the corresponding movement phases a-e of FIG. 1A are labeled on the curve 103. In an embodiment, phases a and b of the stance movement phase 152 are referred to as a flexion phase of the stance moment phase 152 and are indicated by plus signs (+) on the curve 103. In another embodiment, phases b and c of the stance movement phase 152 are referred to as an extension phase of the stance movement phase 152 and are indicated by dark circles (⋅) on the curve 103. In yet another embodiment, the swing movement phase 154 (from phase e to a) is also shown on the curve 103.

The inventors of the present invention recognized from the curve 103 of FIG. 1B that during the stance movement phase 152 the knee joint behaves similar to a torsional spring with a linear moment relative to the knee angle. The labeled slopes K_{f} and Kₑ correspond to a best line fit of the curve 103 for the respective flexion phase and extension phase of the stance movement phase 152. These labeled slopes K_{f} and Kₑ correspond to a stiffness of the knee joint 160 during the respective flexion phase and the extension phase of the stance movement phase 152. In addition to the slopes K_{f} and Kₑ, the graph 100 shows a K slope that represents the stiffness for the entire stance movement phase 152. In an embodiment, the K slope is determined based on a best line fit for the curve 103 over both the flexion phase and extension phase. The inventors of the present invention also realized that the swing phase moment-angle trajectory of the curve 103 is non-linear, making it unviable for extensor moment assistance using a linear spring. Thus, the inventors of the present invention realized that the knee joint is a good candidate for a spring-powered exoskeleton with a clutch that provides an extensor moment during the stance movement phase 152 and allows free motion of the knee joint during the swing movement phase 154.

Based on these recognitions by the inventors of the present invention, an apparatus was designed that is a knee exoskeleton which provides an assistive extensor moment about the knee during the stance movement phase 152 and does not provide an assistive extensor moment during the swing movement phase 154. FIG. 2A is a block diagram that illustrates an example of an apparatus 200 for using a spring-powered knee exoskeleton for gait assistance, according to an embodiment. As shown in FIG. 2A, in an embodiment the apparatus 200 includes a linear spring 206 connected to a pulley 210 attached parallel to the knee joint 160. In one embodiment, the spring 206 creates a knee extensor moment 207 during the stance movement phase 152 that is linearly proportional to the knee angle (e.g. angle between the thigh and the shank). In an example embodiment, the knee extensor moment stiffness k_{θ}(Nm/rad) is proportional to the linear spring stiffness kₗ (N/m) of the spring 206 and a diameter r (m) of the pulley 210 according to the following equation:

$${k}_{θ} = {k}_{l} \times {r}^{2} \qquad ( 1 )$$

In an embodiment, during the swing movement phase 154 the spring 206 does not create the knee extensor moment 207. In an example embodiment, during the swing movement phase 154, little to no extensor moment is created about the knee joint 160 and the knee joint 160 is free to rotate. In an embodiment, the apparatus 200 does not include any electrical components and exclusively includes mechanical components that do not transmit or receive electrical signals.

Another design of the knee exoskeleton will now be discussed, which includes a clutch that is used to prevent the spring from creating the knee extensor moment during the swing movement phase 154 while facilitating the spring creating the knee extensor moment during the stance movement phase 152. FIG. 2B is a block diagram that illustrates an example of an apparatus 200′ for using a spring-powered knee exoskeleton for gait assistance, according to an embodiment. FIG. 2C is an image that illustrates an example of a subject to wear the apparatus 200 of FIG. 2B with an angle formed between the thigh and shank during the gait cycle, according to an embodiment. The subject is not part of the apparatus 200′. The apparatus 200′ includes some of the same components as the apparatus 200 (e.g. spring 206, spring pulley 210, etc.) and thus the description herein will focus on those components not disclosed in the apparatus 200 of FIG. 2A.

As shown in FIG. 2B, in an embodiment the apparatus 200′ includes a first bar or upper bar 202 that is configured to be attached to a thigh 250 (FIG. 2C) above the knee joint 160 of the subject. In this embodiment, the apparatus 200′ also includes a second bar or lower bar 204 configured to be attached to a shank 252 (FIG. 2C) below the knee joint 160. In one example embodiment, the upper and lower bars 202, 204 are attached parallel to (e.g. to the side of) the respective thigh 250 and shank 252. As further shown in FIG. 2B, as with the apparatus of FIG. 2A, the apparatus 200′ includes the linear spring 206 that is attached with the line 208 (e.g. braided fishing line) to the spring pulley 210. The linear spring 206 is attached to the upper bar 202. In an example embodiment, the apparatus 200′ only includes one linear spring.

As shown in FIG. 2B the lower bar 204 is pivotally coupled to the first bar 202 adjacent the knee joint 160 and thus can rotate in different directions 240, 242 relative to the upper bar 202 during the gait cycle 150. As shown in FIG. 2C an angle 254 is defined between a thigh axis 251 (e.g. a longitudinal axis defined along the thigh 250) and a shank axis 253 (e.g. a longitudinal axis defined along the shank 252). During the gait cycle 150, the angle 254 varies. Since the upper bar 202 is attached to the thigh 250 (e.g. with straps) and the lower bar 204 is attached to the shank 252 (e.g. with straps), the angle between the upper and lower bars 202, 204 similarly varies with the angle 254. In one embodiment, the apparatus 200′ also includes a sprocket 222 configured to rotate based on variation of the angle 254 between the upper bar 202 and the lower bar 204 during the gait cycle 150 of the subject.

As shown in FIG. 2B, in an embodiment the apparatus 200′ includes a clutch 220. The clutch 220 is configured to rotatably connect the sprocket 222 with the spring pulley 210 during the stance movement phase 152. Based on this rotatable connection between the sprocket 222 and the spring pulley 210, rotation of the sprocket 222 during the stance movement phase 152 causes rotation of the spring pulley 210 which in turn causes an elongation of the linear spring 206 (via the line 208). Consequently, this elongation of the spring 206 imparts an assistive extensor moment 207 about the knee joint 160. In an example embodiment, the assistive extensor moment 207 about the knee joint 160 is similar to the curve 103 of FIG. 1B for the stance phase 152. In this example embodiment, the assistive extensor moment 207 varies linearly (e.g. with a slope based on slope K of FIG. 1B) with the angle 254 between the upper and lower bars 202, 204. In this example embodiment, a linear stiffness of the spring 206, sprocket 222 ratio, and radius r of the spring pulley 210 are selected using equation 1, such that the resulting stiffness k_{θ} of the knee due to the imparted extensor moment 207 is about equal to the stiffness of the knee during the stance movement phase 152 (e.g. slope K from FIG. 1B). In some embodiments, the sprocket 222 includes a pair of sprockets including a first sprocket (e.g. knee sprocket 330 with a first number of teeth) and a second sprocket (e.g. clutch sprocket 322 with a second number of teeth) that are rotatably connected to each other, where the first sprocket drives the second sprocket. In these embodiments, the clutch 220 is configured to rotatably connect the second sprocket with the spring pulley 210 during the stance movement phase 152 and rotatably disconnect the second sprocket from the spring pulley 210 during the swing movement phase 154. For purposes of this description, “sprocket ratio” means a ratio between the number of first teeth of the first sprocket and a number of second teeth of the second sprocket. In this example embodiment, the knee extensor moment stiffness k_{θ} (Nm/rad) is proportional to the linear spring stiffness kₗ (N/m) of the spring 206, the diameter r (m) of the pulley 210 and the sprocket ratio (T/t) where T is the number of first teeth of the first sprocket and t is the number of second teeth of the second sprocket:

$${k}_{θ} = {k}_{l} \times {{r}^{2} ( \frac{T}{t} )}^{2} \qquad ( 2 )$$

As shown in FIG. 2B, in an embodiment the clutch 220 is further configured to rotatably disconnect the sprocket 222 with the spring pulley 210 during the swing movement phase 154 of the gait cycle 150. Consequently, during the swing movement phase 154, rotation of the sprocket 222 does not cause rotation of the spring pulley 210 nor elongation of the spring 206. As a result, the spring 206 does not impart the assistive extensor moment 207 about the knee joint 160 during the swing movement phase 154 and thus the knee joint 160 is free to move during the swing movement phase 154. The apparatus 200′ advantageously does not lock the knee joint 160 during the swing movement phase 154 (or any movement phase of the gait cycle 150).

In an embodiment, neither the apparatus 200 of FIG. 2A nor the apparatus 200′ of FIG. 2B include electrical components whose function is achieved by transmitting or receiving electrical signals (e.g. power supply, electric motor, electric controller, electronic sensors, etc.). In this embodiment, the apparatuses 200, 200′ exclusively include mechanical components whose function is performed without transmitting or receiving electrical signals. In another embodiment, the apparatus 200′ (each leg) has a total weight of less than about 3 kg. Thus, in this embodiment, the apparatus 200′ for both legs would have a total weight of less than about 6 kg. In another embodiment, the apparatus 200′ (each leg) has a total weight of less than about 2 kg. Thus, in this embodiment, the apparatus 200′ for both legs would have a total weight of less than about 4 kg. In another embodiment, the apparatus 200′ (each leg) has a total weight of about 1 kg. Thus, in this embodiment, the apparatus 200′ for both legs would have a total weight of about 2 kg. In some of these embodiments, one or more components of the apparatus 200, 200′ are 3D printed (e.g. with one of carbon fiber, nylon and Kevlar material).

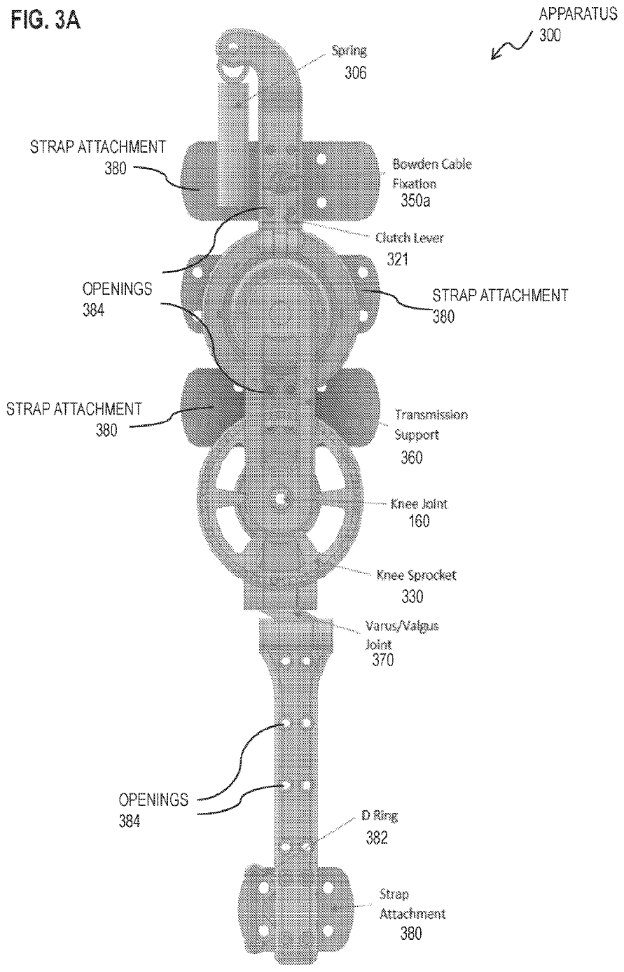

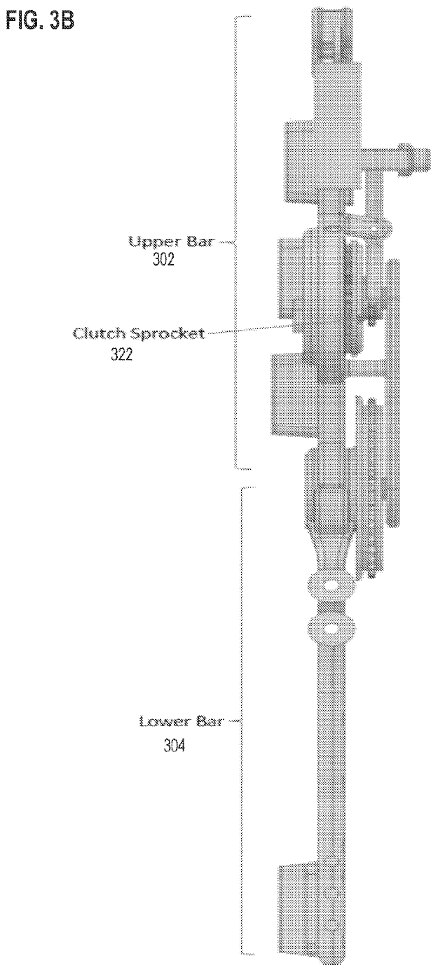

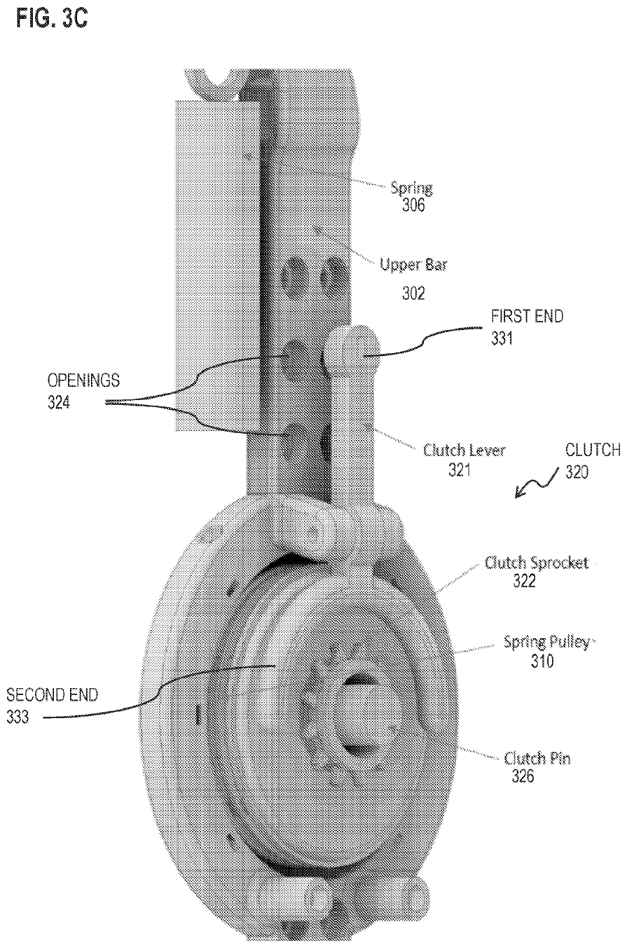

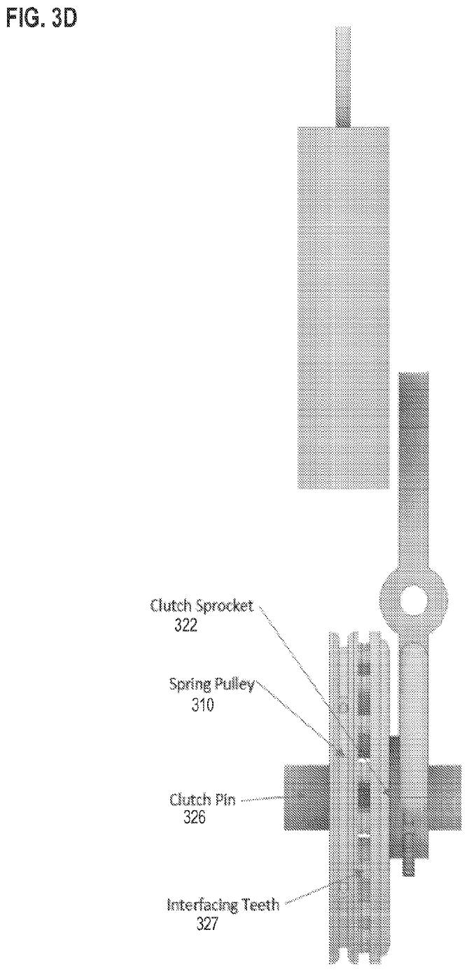

Another design of the apparatus using a spring-powered knee exoskeleton for gait assistance will now be discussed. This apparatus is similar to the apparatuses 200, 200′ previously discussed, with the exception of the features discussed herein. FIGS. 3A through 3D are images that illustrate example views of an apparatus 300 for using a spring-powered knee exoskeleton for gait assistance, according to an embodiment. The respective upper bar 302, lower bar 304, spring 306, line 308, spring pulley 310, clutch 320, clutch sprocket 322 of the apparatus 300 are similar to the respective upper bar 202, lower bar 202, spring 206, line 208, spring pulley 210, clutch 220 and sprocket 222 of the apparatus 200.

As shown in FIG. 3A, in an embodiment the second bar 304 is pivotally coupled to the first bar 302 at a knee sprocket 330 that is configured to be positioned adjacent the knee joint 160. In these embodiments, the knee sprocket 330 is pivotally coupled to a clutch sprocket 322 such that rotation of the knee sprocket 330 during the gait cycle 150 causes rotation of the clutch sprocket 322. In an example embodiment, the knee sprocket 330 and the clutch sprocket 322 are fixed to transmission support 360 and rotationally connected with a transmission drive 520 (e.g. chain). In this example embodiment, each of the knee and clutch sprockets 330, 322 revolve around respective pins where a first end of the respective pins is connected to the upper bar 302 (for the clutch sprocket 322) and to the lower bar 304 (for the knee sprocket 322). An opposite end of these respective pins is connected to the transmission support 360 which stabilizes the transmission so that deflection of the pins under load is minimal.

As shown in FIGS. 3A and 3C, the apparatus 300 includes a clutch 320 that acts in a similar manner as the clutch 220 of FIG. 2B. In an embodiment, the apparatus 300 includes a clutch sprocket 322 that acts in a similar manner as the sprocket 222 of the apparatus 200. In this embodiment, the clutch 320 of the apparatus 300 is configured to rotatably connect the clutch sprocket 322 with the spring pulley 310 during the stance movement phase 152 and to rotatably disconnect the clutch sprocket 322 with the spring pulley 310 during the swing movement phase 154.

As shown in FIGS. 3A and 3C, the clutch 320 also includes a clutch lever 321 configured to move to a first position during the stance movement phase 152 of the gait cycle 150 and a second position during the swing movement phase 154. As shown in FIG. 3C, in one embodiment the clutch lever 321 includes a first end 331 with an extension (not shown) configured to be received within one of a plurality of openings 324 and a second end 333 opposite to the first end 331. The clutch lever 321 is pivotally mounted to the upper bar 302 so that movement of the first end 331 causes movement of the second end 333 in an opposite direction.

As shown in FIGS. 3C and 3D, the clutch sprocket 322 and spring pulley 310 each have an opening through which a clutch pin 326 is passed so that the clutch sprocket 322 and the spring pulley 310 are slidably received along the clutch pin 326. Each of the clutch sprocket 322 and the spring pulley 310 have interfacing teeth 327 such that when the clutch sprocket 322 and the spring pulley 310 are brought together along the clutch pin 326, the interfacing teeth 327 of the clutch sprocket 322 engage the interfacing teeth 327 of the spring pulley 310 which rotatably connects the spring pulley 310 and the clutch sprocket 322. The clutch lever 321 is moved to the first position based on a cable (not shown) attached to a cable fixation 350a (e.g. Bowden cable fixation) at the first end 331 pulling the first end 331 away from the upper bar 302. In an embodiment, the cable fixation 350a is attached to the upper bar 302 through the openings 384. Consequently, the extension (not shown) at the first end 331 is removed from the one of the plurality of openings 324 and the second end 333 pushes the clutch sprocket 322 towards the spring pulley 310 along the clutch pin 326 until the interfacing teeth 327 of the clutch sprocket 322 engage the interfacing teeth 327 of the spring pulley 310. This results in the clutch sprocket 322 being rotatably connected with the spring pulley 310.

The clutch lever 321 is also configured to move to the second position during the swing movement phase 154. In the second position, the clutch lever 321 is configured to not rotatably connect the clutch sprocket 322 with the spring pulley 310. In the second position, the first end 331 of the clutch lever 321 moves towards the upper bar 302 so the extension (not shown) is received in one of the plurality of openings 324. Consequently, the second end 333 of the clutch lever 321 moves away from the spring pulley 310 and no longer causes the interfacing teeth 327 of the spring pulley 310 to engage the interfacing teeth 327 of the clutch sprocket 322. Additionally, compression springs (not shown) are positioned between the spring pulley 310 and the clutch sprocket 322 in FIG. 3D and hence these compression springs separate the spring pulley 310 from the clutch sprocket 322 in the absence of the second end 333 of the clutch lever 321 no longer pushing the clutch sprocket 322 into the spring pulley 310.

When the clutch lever 321 has moved to the second position, in an example embodiment the lack of rotatable connection between the clutch sprocket 322 with the spring pulley 310 results in the upper and lower bars 302, 304 being free to rotate during the swing movement phase 154 and consequently the knee joint 160 being free to rotate during the swing movement phase 154.

As shown in FIG. 3A, the apparatus 300 includes a joint 370 (e.g. Varus/Valgus joint) configured to act as a hinge between a first portion (e.g. knee sprocket 330) of the second bar 304 and a second portion (e.g. strap attachment 380) of the second bar 304 to permit alignment of the first portion and the second portion of the second bar 304 with the shank 252 of the subject below the knee 160.

The apparatus 300 is attached to a subject using one or more straps. Some strap attachments of the apparatus 300 will now be discussed. As shown in FIG. 3A, the apparatus 300 includes one or more openings 384 in the lower bar 304 and upper bar 302. In an embodiment, strap attachments 380 can be attached to the upper bar 302 or lower bar 304 at these openings 384 to facilitate attaching the apparatus 300 to the thigh 250 or shank 252 of the subject using straps (not shown). In an example embodiment, the strap attachment 380 includes a D-ring 382 that is connected to one or more of the openings 384 after which a first end of the strap (not shown) is secured to the strap attachment 380 and wrapped around the thigh 250 or shank 252 after which a second end of the strap is also secured to the strap attachment 380.

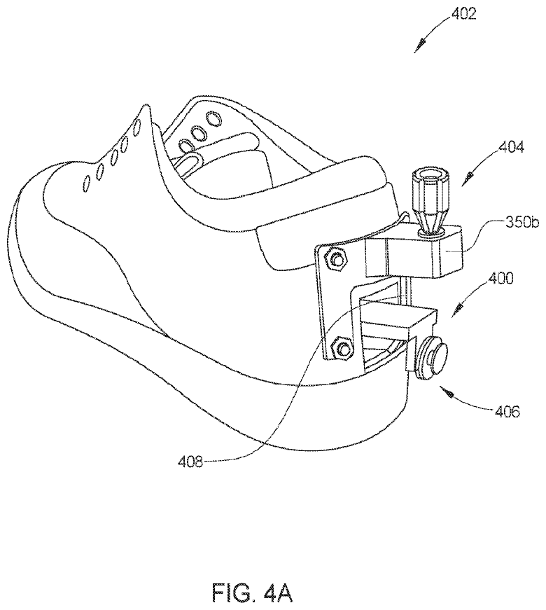

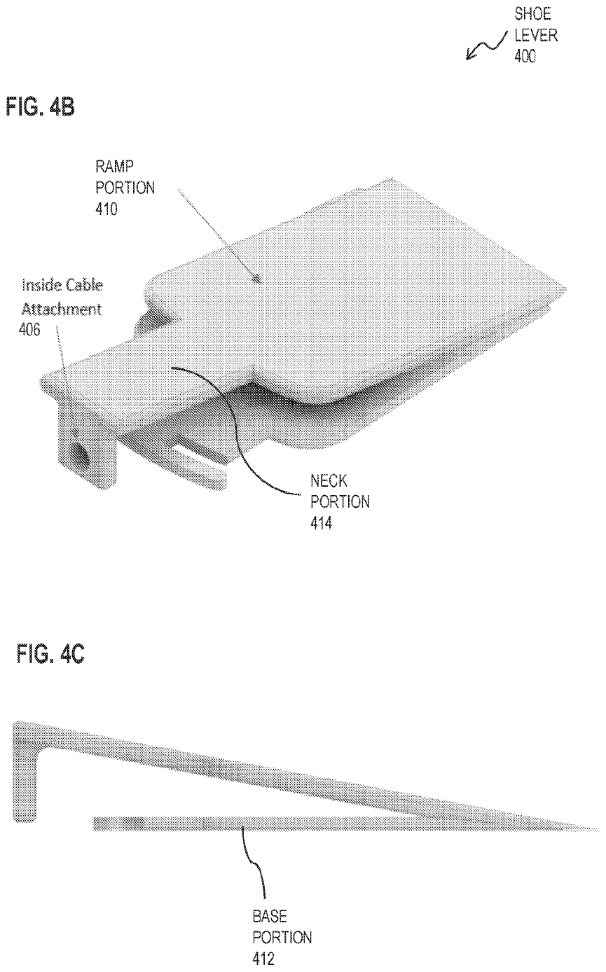

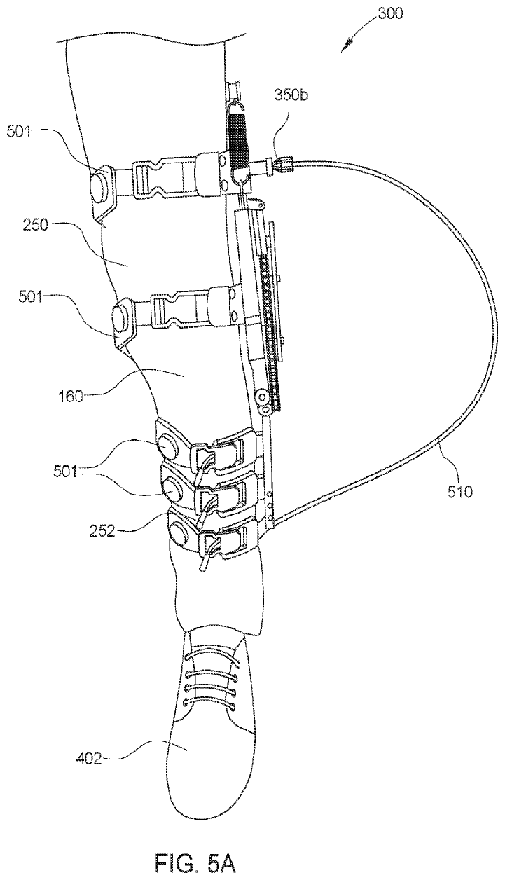

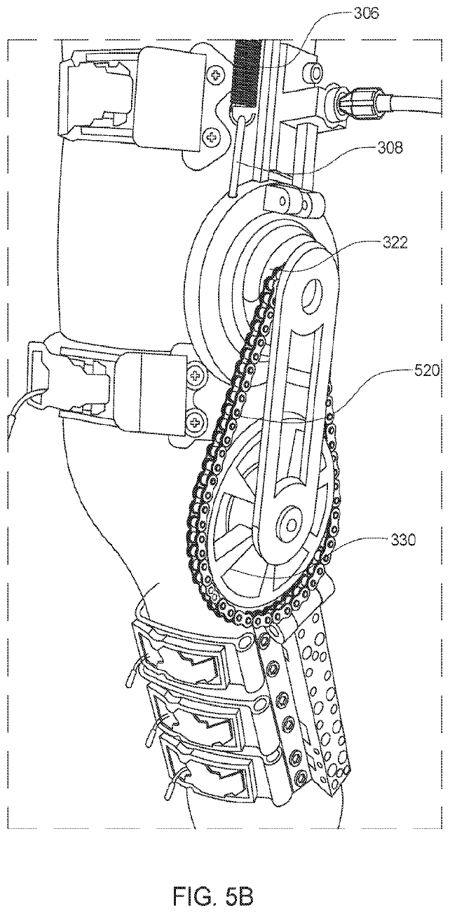

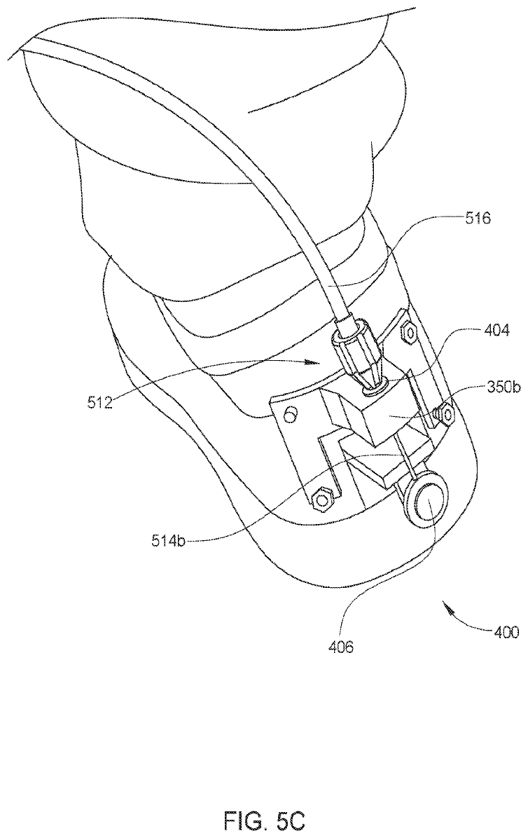

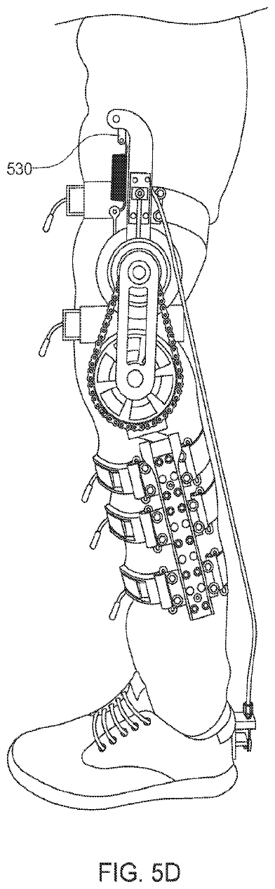

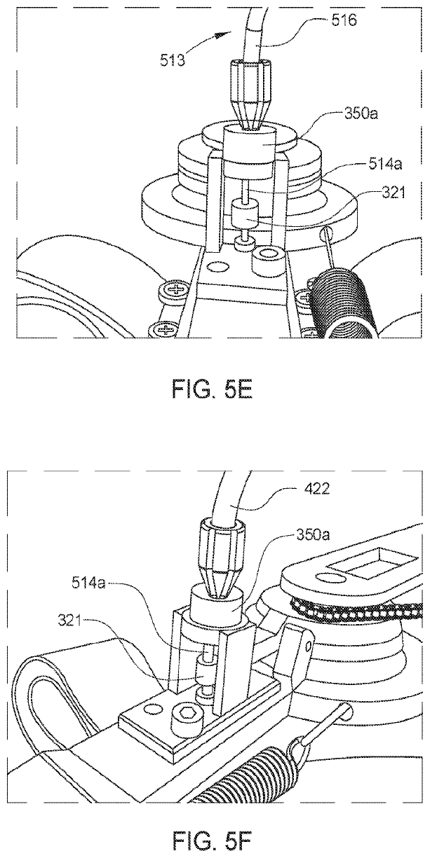

As previously discussed, the clutch lever 321 is moved to the first position based on a cable pulling at a cable attachment 350a at the first end 331 of the clutch lever 321. This is discussed more in detail with respect to FIGS. 5E and 5F. A shoe lever is now discussed which is used to pull the cable and move the clutch lever 321 to the first position during the stance movement phase 152. FIG. 4A is an image that illustrates an example of a rear perspective view of a shoe lever 400 of the apparatus 300 of FIG. 3A for a shoe 402, according to an embodiment. FIG. 4B is an image that illustrates an example of a top perspective view of the shoe lever 400 of FIG. 4A, according to an embodiment. FIG. 4C is an image that illustrates an example of a side view of the shoe lever 400 of FIG. 4A, according to an embodiment.

As shown in FIGS. 4B and 4C, in an embodiment the shoe lever 400 includes a ramp portion 410 that is configured to move relative to a base portion 412. The base portion 412 and the ramp portion 410 are positioned within the shoe 402. In some embodiments the ramp portion 410 and the base portion 412 are integral with each other. The shoe lever 400 also includes an inside cable attachment 406 that is continuous with the ramp portion 410 (via a neck portion 414). As shown in FIG. 4A, a heel portion of a shoe 402 has a formed slot to receive the neck portion 414 so that the inside cable attachment 406 is positioned outside the shoe 402. Also, as shown in FIG. 4A in one embodiment a curved plate 408 is mounted to the heel portion of the shoe 402 and includes an outer tube attachment 404. In an embodiment, the shoe lever 400 is 3D printed and/or is made from one of carbon fiber, nylon and Kevlar material.

A first end of a cable is attached to the cable fixation 350a of the first end 331 of the clutch lever 321. A second end of the cable is attached to the cable fixation 350b of the shoe lever 400. In one embodiment, the cable has an outer tube that surrounds an inner cable. In this embodiment, the outer tube of the cable is attached to the outer tube attachment 404 of FIG. 4A and the inner cable of the cable is attached to the inner cable attachment 406 of FIG. 4A. Thus, only the inner cable extends from the outer tube attachment 404 to the inner cable attachment 406 of the shoe lever 400.

FIGS. 5A through 5F are images that illustrate examples of various views of the apparatus 300 of FIG. 3A worn on thigh 250 and shank 252 of a subject, according to an embodiment. As shown in FIG. 5A, one or more straps 501 are used to attach the upper bar 302 and lower bar 304 to the subject. In one embodiment, one or more straps 501 are passed through a strap attachment 380 and D-ring 382 secured to one or more of the openings 384 in the upper bar 302, to secure the apparatus 300 to the thigh 250. Additionally, in another embodiment, one or more straps 501 are passed through a strap attachment 380 and D-ring 382 secured to one or more of the openings 384 in the lower bar 304 to secure the apparatus 300 to the shank 252.

As shown in FIG. 5A, a cable 510 is provided with a first end 513 of the cable 510 attached to the cable fixation 350a at the first end 331 of the clutch lever 321. Additionally, the cable has a second end 512 (FIG. 5C) opposite from the first end 513 that is attached to the shoe lever 400. In one embodiment, the cable 510 includes an outer tube 516 that encloses an inner cable 514. In an example embodiment, as shown in FIG. 5C the outer tube 516 of the cable 510 is attached to the outer tube attachment 404, the inner cable 514b of the cable 510 is attached to the inner cable attachment 406 and only the inner cable 514b extends from the outer tube attachment 404 to the inner cable attachment 406. For purposes of this description, the inner cable 514b references that portion of the inner cable 514 which extends between the outer tube attachment 404 and the inner cable attachment 406 of the shoe lever 400.

As shown in FIG. 5B, in an embodiment the chain 520 rotatably connects the knee sprocket 330 and clutch sprocket 322. Also, as shown in FIG. 5D in an embodiment the spring 308 is mounted to the upper bar 302 at a spring mount 530. In an example embodiment, the spring mount 530 is a curved shaped end of the upper bar 302 which includes a link to connect with one end of the spring 306 whereas the other end of the spring 306 is connected to the spring pulley 310 via the line 308.

The attachment of the first end 513 of the cable 510 to the cable fixation 350a at the first end 331 of the clutch lever 321 will now be discussed. FIG. 5E is an image that illustrates an example of a front view of the clutch lever 321 of the apparatus 300 of FIG. 5A, according to an embodiment. FIG. 5F is an image that illustrates an example of a side perspective view of the clutch lever 321 of the apparatus 300 of FIG. 5A, according to an embodiment. In an embodiment, as shown in FIG. 5E the outer tube 516 of the first end 513 of the cable 510 is attached to the outer tube attachment 404 of the cable fixation 350a and the inner cable 514a is attached to the first end 331 of the clutch lever 321. For purposes of this description, the inner cable 514a references that portion of the inner cable 514 that extends between the outer tube attachment 404 of the cable fixation 350a and the first end 331 of the clutch lever 321. In an example embodiment, only the inner cable 514a extends from the outer tube attachment 404 to the first end 331 of the clutch lever 321.

The dynamics of the inner cable 514a, 514b during the gait cycle 150 will now be discussed. In an embodiment, during the gait cycle 150, a length of the inner cable 514a and a length of the inner cable 514b have an inverse relationship. In this embodiment, during certain movement phases of the gait cycle 150 (e.g. swing movement phase 154) a shortening of the inner cable 514b at the shoe side of the apparatus 300 causes a lengthening of the inner cable 514a at the exoskeleton end of the apparatus 300. Additionally, in this embodiment, during other movement phases of the gait cycle 150 (e.g. stance movement phase 152), a lengthening of the inner cable 514b at the shoe side of the apparatus 300 causes a shortening of the inner cable 514a at the exoskeleton end of the apparatus 300. When the gait cycle 150 enters the stance movement phase 152 (e.g. phases a-c of FIG. 1A) the foot presses down on the ramp portion 410 which causes the ramp portion 410 to move downward towards the base portion 412 within the shoe 402 and further causes the ramp portion 410 to pull the inner cable attachment 406 apart from the outer tube attachment 404, thereby lengthening the inner cable 514b. This results in a shortening of the inner cable 514a at the exoskeleton side of the apparatus 300. Consequently, the shortening of the inner cable 514a causes the inner cable 514a to pull the first end 331 of the clutch lever 321 towards the cable fixation 350a, pivoting the clutch lever 321 to the first position and thus engaging the clutch 320. Consequently, the clutch lever 321 rotatably connects the clutch sprocket 322 with the spring pulley 310 during the stance movement phase 152. As a result, the spring 308 advantageously imparts the assistive extensor moment 207 about the knee joint 160. Since the foot remains in contact with the ramp portion 410 during the stance movement phase 152, the assistive extensor moment 207 is continuously imparted during the stance movement phase 152.

When the gait cycle 150 enters the swing movement phase 154 (e.g. phase e of FIG. 1A) the foot and shoe 402 come off the ground which removes the force pushing the ramp portion 410 towards the base portion 412 and instead the ramp portion 410 separates and moves upward relative to the base portion 412. Consequently, the inner cable attachment 406 (e.g. integral with the ramp portion 410) moves closer to the shoe lever 400, thereby shortening the inner cable 514b at the shoe end of the apparatus 300. This results in a lengthening of the inner cable 514a at the exoskeleton end of the apparatus 300, pivoting of the first end 331 of the clutch lever 321 to the second position away from the cable fixation 350a and disengaging the clutch 320. The compression springs between the clutch sprocket 322 and the spring pulley 310 push the clutch sprocket 322 and spring pulley 310 apart which rotatably decouples the clutch sprocket 322 from the spring pulley 310. Consequently, rotation of the knee sprocket 330 and clutch sprocket 322 does not translate to the spring pulley 310, thus the spring 308 is not elongated and hence the assistive extensor moment 207 is not imparted on the knee joint 160.

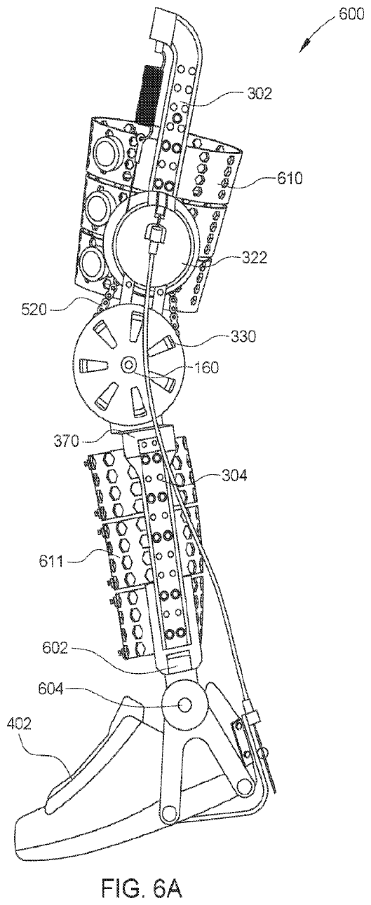

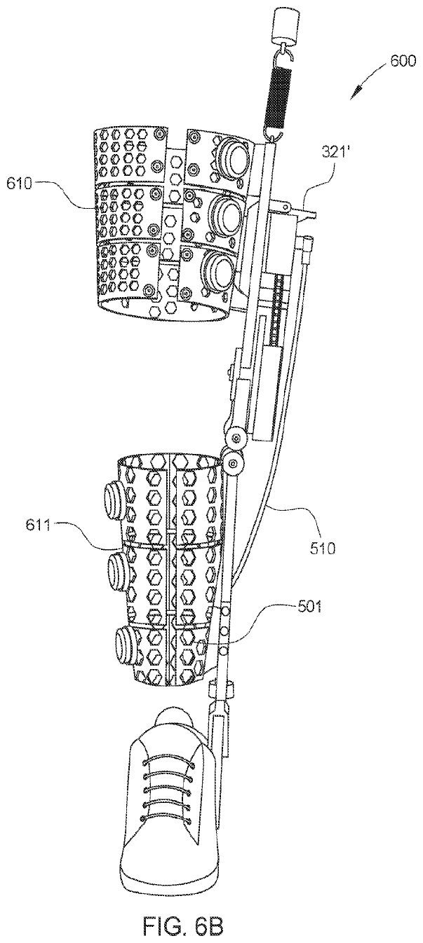

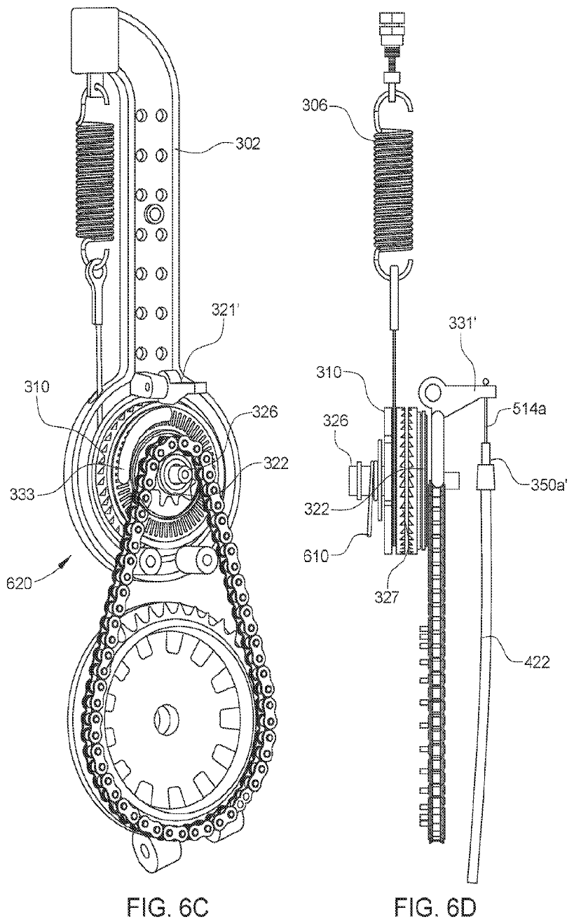

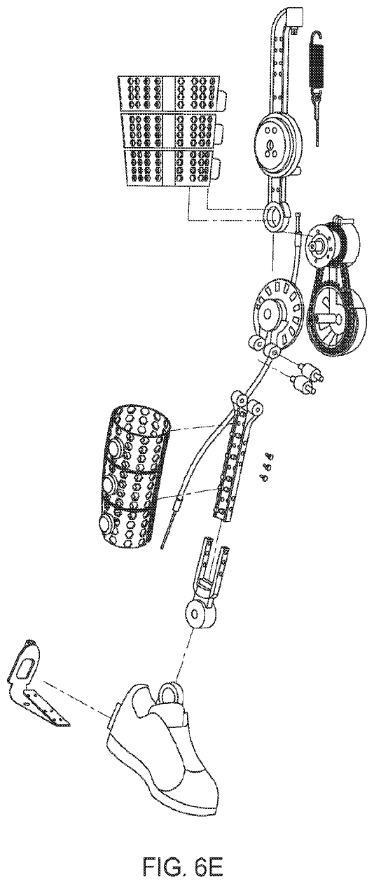

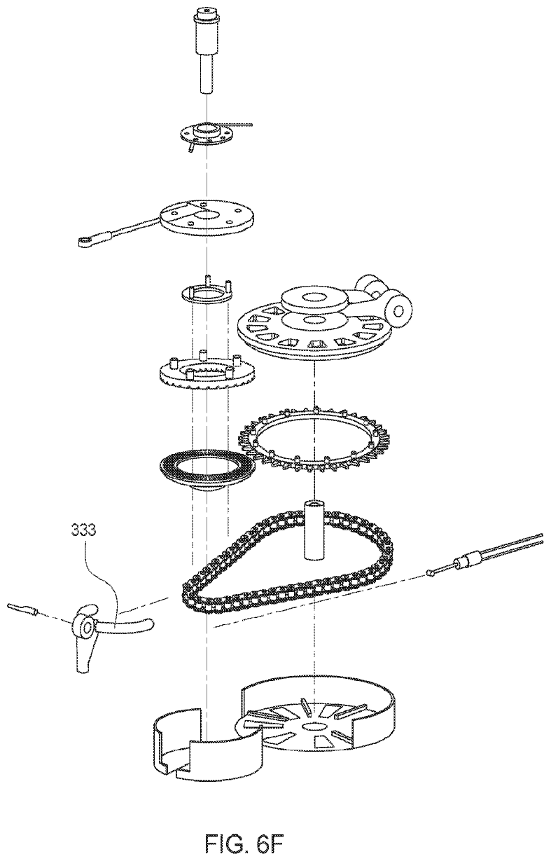

Another embodiment of the apparatus for using the spring-powered knee exoskeleton for gait assistance will now be discussed. FIGS. 6A through 6F depict this embodiment of the apparatus 600. The apparatus 600 depicted in FIGS. 6A through 6F is similar to the apparatus 300 discussed above and depicted in FIGS. 3A through 3D with the exception of the features discussed herein. Thus, duplicate components of the apparatus 600 that were previously discussed with respect to the apparatus 300 will not be repeated herein.

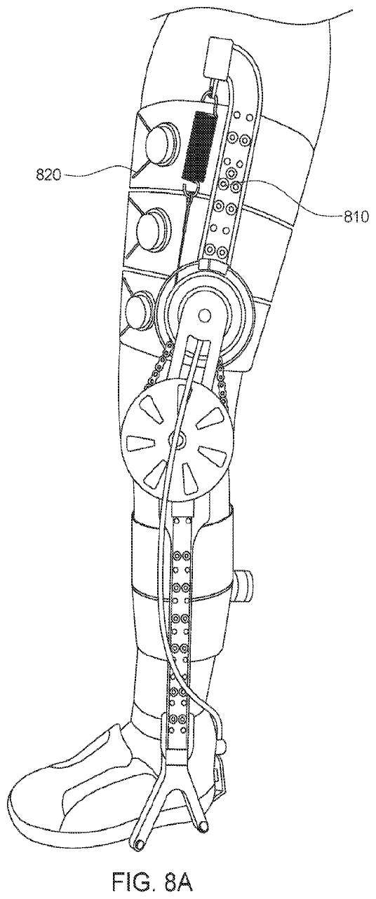

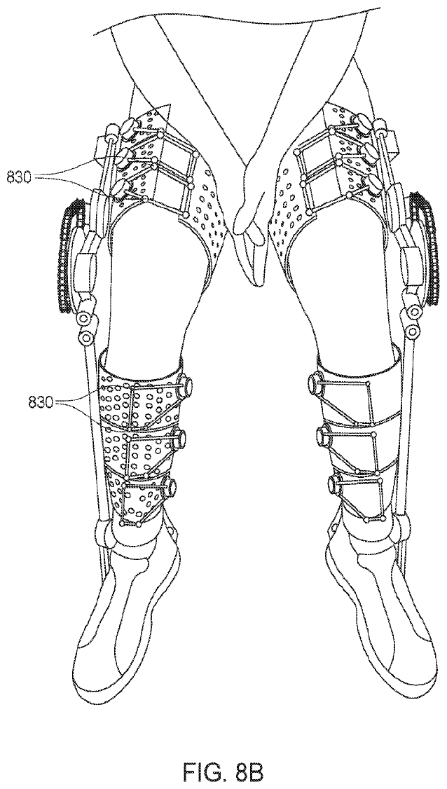

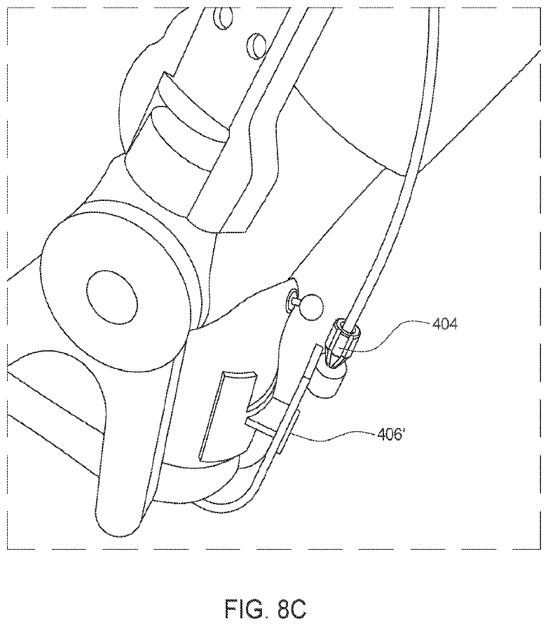

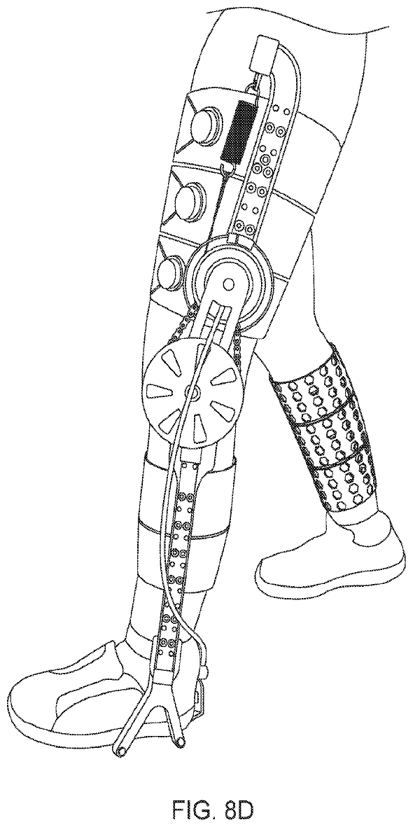

In an embodiment, unlike the apparatus 300 which secured to the subject using straps 501 (FIG. 5A) that pass through the openings 384 of the upper and lower bars 302, 304 the apparatus 600 of FIGS. 6A through 6F is secured to the subject using collars 610, 611 that are secured to the openings 384 of the upper and lower bars 302, 304 (e.g., using bolts 810 shown in FIG. 8A). As shown in FIGS. 6A and 6B the collars 610, 611 have a diameter that is larger than an outer diameter of the respective thigh and shank of the subject. This facilitates the thigh and the shank of the subject being passed through the collars 610, 611. As shown in FIG. 6B, the collars 610, 611 have a break in the circumference and are constructed from a compliant material, which advantageously permits the collars 610, 611 to adaptively secure to thighs and shanks of various thicknesses. Once the thigh and shank of the subject is passed through the collars 610, 611, a cable is extended from BOA reel 606 (FIG. 6B) and passed over one or more pins 830 (FIG. 8B) to securely attach the collars 610, 611 around the respective thigh and shank. Also in this example embodiment, the BOA Reels 606 tighten the cables 820 around the subject to provide a snug fit. FIG. 8A depicts an example embodiment of the cable 820 extending from the BOA reel 606 before being passed over the pins 830 until the collars 610, 611 are secured to the thigh and shank. Also in this example embodiment, the BOA reels 606 tighten the cables 820 to deform and tighten the compliant collars 610, 611 around the subject thigh and shank and provide a snug fit. In this example embodiment, the collars 610, 611 transmit the knee extensor moments from the apparatus 600 to the subject and help align the bars 302, 304 (FIG. 6A) to the thigh 250 and shank 252. The collars 610, 611 are compliant and deform to fit the subject's leg shape. Additional holes throughout the collars 610, 611 make them breathable for increased subject comfort.

In an embodiment, unlike the apparatus 300 where the clutch lever 321 (FIG. 3C) is arranged so that the first end 331 and the second end 333 are aligned along a common axis, the apparatus 600 features a modified clutch lever 321′ (FIGS. 6B and 6D) where the first end 331′ is oriented at an angle (e.g. about 90 degrees or in a range from about 70 degrees to about 110 degrees) relative to the second end 333 which is similar as depicted in the apparatus 300. Accordingly, unlike the apparatus 300 where the first end 331 moves into one of the openings 324 (FIG. 3C) in the first position, the first end 331′ moves/rotates upward (viewing FIG. 6D) in the first position which causes the second end 333 to rotate to the first position. As with the apparatus 300, in the first position the inner cable 514a is lengthened and the inner cable 514 is shortened. Similarly, unlike the apparatus 300 where the first end 331 moves out of one of the openings 324 (FIG. 3C) to the second position, the first end 331′ moves/rotates downward (viewing FIG. 6D) in the second position which causes the second end 333 to move/rotate to the second position and rotatably secure the clutch sprocket 322 and spring pulley 310. Thus, while the clutch lever 321′ is similarly rotatably secured to the apparatus 600, the clutch lever 321′ is structurally arranged different than the clutch lever 321 of the apparatus 300.

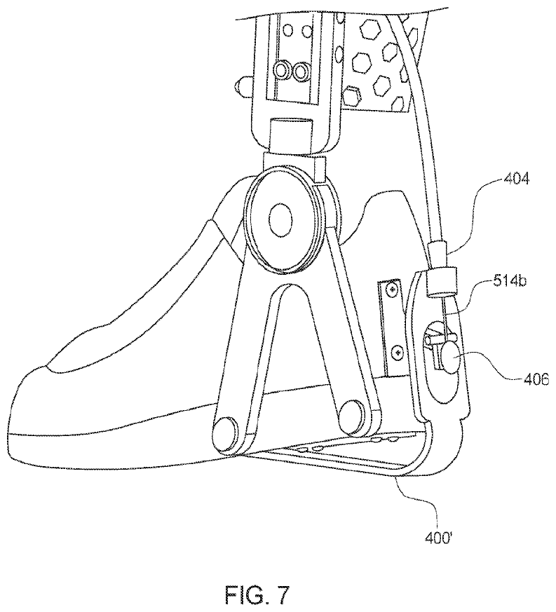

In an embodiment, unlike the apparatus 300 where the shoe lever 400 (FIG. 5C) is arranged such that the shoe 402 is only attached to the apparatus 300 via the curved plate 408 (FIG. 4A). In the apparatus 600 both sides of the shoe 402 are secured to the apparatus 600 with an ankle joint 604 and internal/external rotation joint 602 (FIG. 6A) which facilitate rotation of the shoe 402 along multiple axes (e.g. plantar-dorsiflexion plane via the ankle joint 604 and internal/external plane via the joint 602). In an example embodiment, the lower bar 304 of the exoskeleton apparatus 600 connects to the shoe 402. The shoe 402 prevents downward shift of the apparatus 600 relative to its user, which may cause exoskeleton misalignment. A single hinge ankle joint 604 allows free rotation of the subject's ankle without resistance. An additional internal/external rotation joint 602 allows ankle rotation and increases subject comfort. As shown in FIG. 7, in one embodiment, a pair of bolts are provided on each side of the shoe 402 to rotatably secure each side of the shoe 402 to the joints 602, 604 of the apparatus 600. As further shown in FIGS. 6A and 7, the shoe lever 400′ incorporates the ramp portion 410 which is outside the shoe 402 (rather than within the shoe 402 in the shoe lever 400 of FIGS. 4A through 4C). As with the shoe lever 400 of FIGS. 4A through 4C, the shoe lever 400′ facilitates the lengthening of the inner cable 514b in the stance movement phase 152 and shortening of the inner cable 514b in the swing movement phase 154 (in order to facilitate the movement of the apparatus into the respective second and first positions).

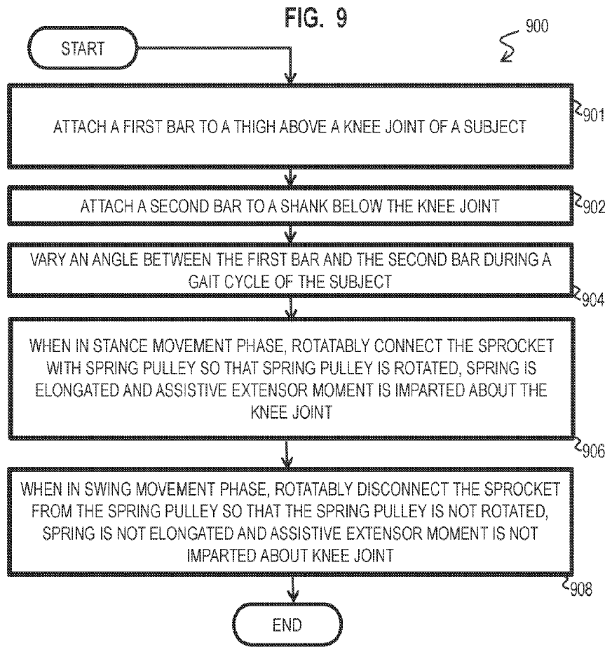

A method is now presented which includes one or more steps for using the apparatus 300, 400. FIG. 9 is a flow diagram that illustrates an example of a method 900 for using a spring-powered knee exoskeleton for gait assistance, according to an embodiment. Although the flow diagram of FIG. 9 is depicted as integral steps in a particular order for purposes of illustration, in other embodiments one or more steps, or portions thereof, are performed in a different order, or overlapping in time, in series or in parallel, or are deleted, or one or more other steps are added, or the method is changed in some combination of ways.

In step 901, the upper bar 302 is attached to the thigh 250 above the knee joint 160. In an embodiment, in step 901 one end of the straps 501 are secured to the strap attachment 380 and D-ring 382 mounted to the openings 384 in the upper bar 302. The straps 501 are then wrapped around the thigh 250 and the opposite side of the straps 501 is secured to the strap attachment 380. In another embodiment, the thigh 250 is inserted through the collars 610 and the collars 610 are secured around the thigh as discussed herein.

In step 902, the lower bar 304 is attached to the shank 252 below the knee joint 160. In an embodiment, in step 602 one end of the straps 501 are secured to the strap attachment 380 and D-ring 382 mounted to the openings 384 in the lower bar 304. The straps 501 are then wrapped around the shank 252 and the opposite side of the straps 501 is secured to the strap attachment 380. In another embodiment, the shank 252 is inserted through the collars 611 and the collars 611 are secured around the shank 252 as discussed herein.

In another embodiment, the method 900 also includes additional steps for securing the apparatus 300 to the subject. In one embodiment, the ramp portion 410 and the base portion 412 of the shoe lever 400 are positioned within the shoe 402. Additionally, in this embodiment, the neck portion 414 of the shoe lever 400 is passed through the opening (not shown) in the heel of the shoe 402 so that the inside cable attachment 406 is outside the shoe 402. Alternatively, as discussed with respect to the apparatus 600, the shoe lever 400′ is presented where the ramp portion is outside the shoe 402. In this embodiment, a pair of bolts are provided to secure the apparatus 600 to each side of the shoe 402 so that the shoe is rotatably secured about the joints 602, 604. As shown in FIGS. 7 and 8C, the outer tube attachment 404 and inside cable attachment 406 are mounted outside of the shoe 402.

The first end 513 of the cable 510 is secured to the cable fixation 350a at the first end 331, 331′ of the clutch lever 321, 321′. The second end 512 of the cable 510 is then secured to the shoe lever 400, 400′. In an example embodiment, as shown in FIG. 5C the second end 512 of the cable 510 is secured to the shoe lever 400 by attaching the outer tube 516 of the cable 510 to the outer tube attachment 404 and securing the inner cable 514b to the inner cable attachment 406. A similar arrangement is depicted in FIG. 7 for the shoe lever 400′. The clutch lever 321 is then moved to the second position (such that the extension at the first end 331 of the clutch lever 321 is positioned within one of the openings 324). With respect to the clutch lever 321′, it is moved to the second position so that the first end 331′ of the clutch lever 321′ moves to a highest position (viewing FIG. 6D).

In step 904, the subject walks over the gait cycle 150 while wearing the apparatus 300, 600. During step 904, the angle 254 (FIG. 2C) between the thigh 250 or upper bar 302 and the shank 252 or lower bar 304 varies. In this embodiment, during step 904 the knee joint 160 moves between the different movement phases of the gait cycle 150.

In step 906, when the knee joint moves into the stance movement phase 152, the clutch sprocket 322 is rotatably connected with the spring pulley 310. In one embodiment, this rotatable connection in step 906 is performed based on the ramp portion 410 moving down and towards the base portion 412 in the shoe 402, which in turn causes the inner cable 514b to lengthen and the inner cable 514a at the exoskeleton side of the apparatus 300, 600 to shorten. Consequently, the first end 331, 331′ of the clutch lever 321, 321′ is rotated to the first position. As previously discussed, when the clutch lever 321, 321′ is moved to the first position, the second end 333 of the clutch lever 321, 321′ pushes the interfacing teeth 327 of the clutch sprocket 322 along the clutch pin 326 until they engage the interfacing teeth 327 of the spring pulley 310. This causes the spring pulley 310 to rotate with the clutch sprocket 322, resulting in elongation of the spring 306 and the assistive extensor moment 207 being imparted about the knee joint 160.

In step 908, when the knee joint moves into the swing movement phase 154, the clutch sprocket 322 is rotatably disconnected from the spring pulley 310. In one embodiment, the disconnection in step 908 is performed based on the ramp portion 410 moving up and away from the base portion 412 in the shoe 402 (due to the foot leaving the ground during the swing movement phase 154). This in turn causes the inner cable 514b to shorten and the inner cable 514a at the exoskeleton side of the apparatus 300 to lengthen. Consequently, the first end 331 of the clutch lever 321 rotates to the second position. A similar scenario occurs with respect to the shoe lever 400′ of the apparatus 600 where the ramp portion (below the shoe 402) moves up causing the inner cable 514b (FIG. 7) to shorten and thus the inner cable 514a of the apparatus 600 to lengthen (FIG. 6D) and thus causing the first end 331′ to rotate to the second position (e.g., downward position viewing FIG. 6D).

As previously discussed, when the clutch lever 321, 321′ is moved to the second position, the second end 333 of the clutch lever 321, 321′ moves away from the clutch sprocket 322 and thus no longer pushes the clutch sprocket 322 to rotatably connect with the spring pulley 310. In an example embodiment, in the absence of the clutch lever 321, 321′ pushing the clutch sprocket 322 towards the spring pulley 310, the compression springs between the clutch lever 321 and clutch sprocket 322 separate them so they are rotatably disconnected. This causes the spring pulley 310 to not rotate with the clutch sprocket 322, resulting in no elongation of the spring 306 and consequently no assistive extensor moment 207 being imparted about the knee joint 160.

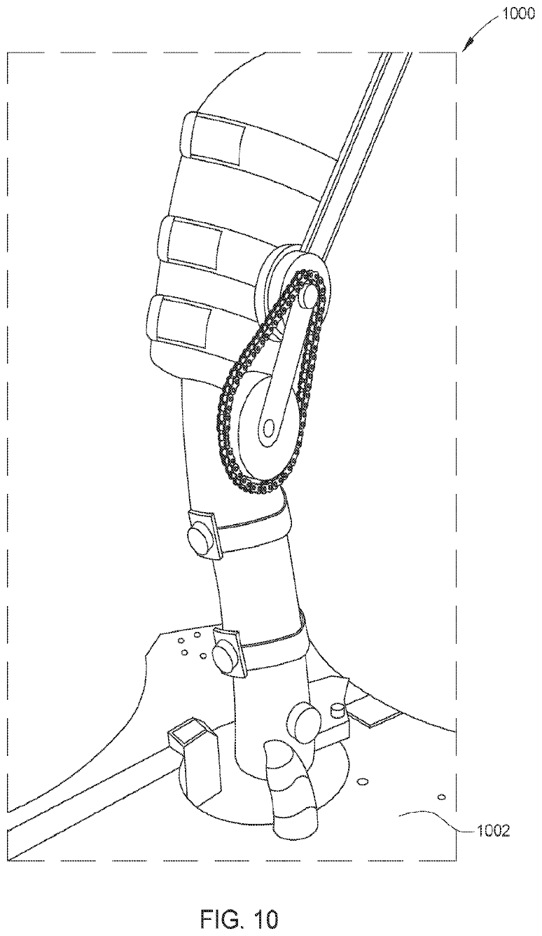

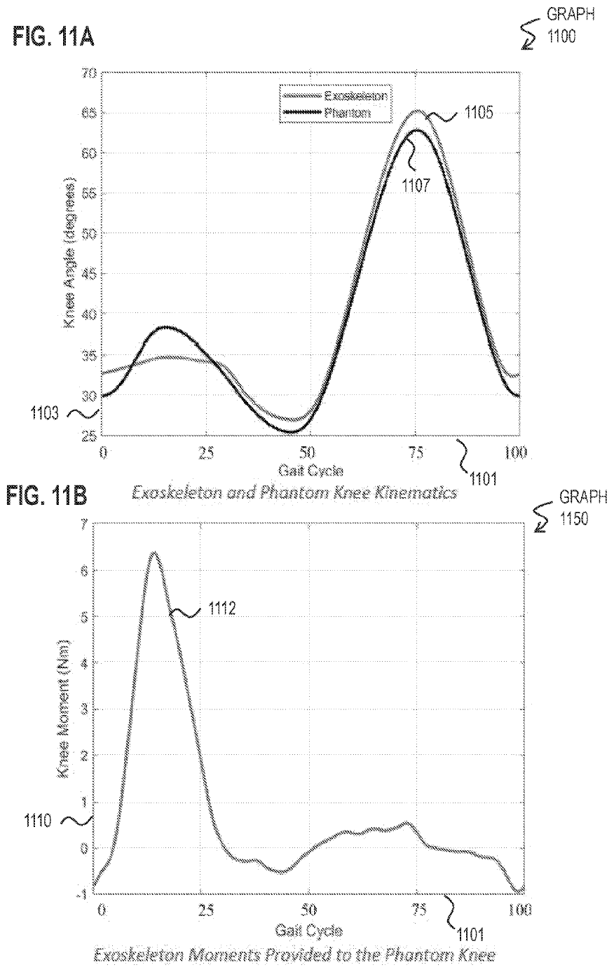

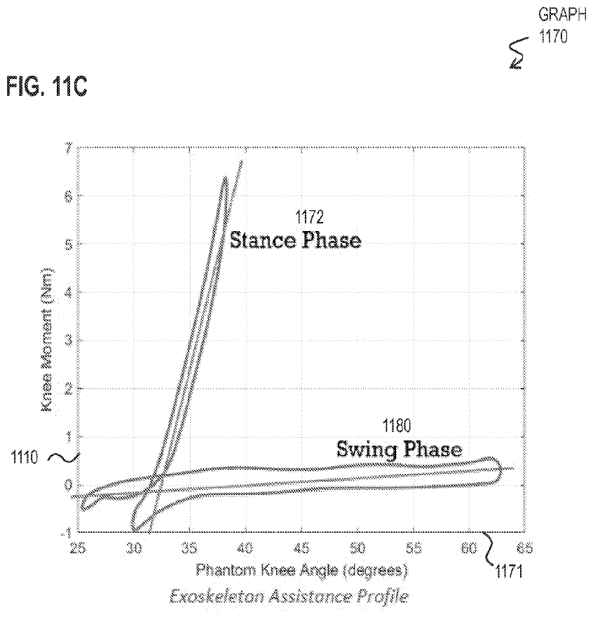

Performance data of the apparatus will now be discussed. FIG. 10 is an image illustrating an example of a phantom leg 1000 wearing the apparatus 600 of FIG. 6A for purposes of testing the apparatus, according to an embodiment. FIGS. 11A through 11C are graphs 1100, 1150, 1170 illustrating an example of one or more curves that are used to measure the performance of the apparatus for using a spring-powered knee exoskeleton for gait assistance, according to an embodiment.

The apparatus 600 was placed around the phantom leg 1000 and a motorized base 1002 (FIG. 10) was programmed to flex the knee simulating a person walking with a crouch gait pattern. In some embodiments, the apparatus disclosed herein can provide rehabilitation assistance to children with crouch gait caused by cerebral palsy. The motorized base 1002 also pulled on the Bowden cable 510 to engage the exoskeleton spring 306 only during stance movement phase 152 of the gait cycle 150. In addition to an apparatus 600 positioned on the phantom leg 1000, for purposes of this performance data assessment another apparatus 600 is placed on a leg of a subject. The performance of the apparatus 600 on the phantom leg 1000 is then compared with the performance of the apparatus 600 on the subject leg. The graphs of FIGS. 11A through 11C depict performance data related to this assessment.

The first graph 1100 of FIG. 11A shows the knee angle over the entire gait cycle 150 for the phantom leg 1000 and the apparatus 600. The horizontal axis 1101 is a percentage of the gait cycle that has been walked, in values of percentage (%). The vertical axis 1103 is the knee angle 254 (FIG. 2C) in units of degrees. Ideally, the exoskeleton knee would track the phantom knee with perfect accuracy. However, soft-tissue deformation at the human-exoskeleton interface can deform and lead to device migration relative to the leg and joint misalignments. The graph 1100 shows an increased joint misalignment during the stance phase (0%-40%), which corresponds to the time when the spring is engaged, and the apparatus 300, 600 provides an extensor moment to the joint. It is hypothesized that soft-tissue compression under external load is the main cause for such misalignments.

The second graph 1150 of FIG. 11B shows the assistance moments the exoskeleton provides during the gait cycle. The vertical axis 1110 is knee moment in units of N-m. The exoskeleton apparatus 300, 600 provides a knee extensor moment peak during stance and low to zero moments during the swing phase (40%-60%). The apparatus 300, 600 allows for unconstrained knee flexion during swing movement phase 154 while providing assistance in stance movement phase 152.

The third graph 1170 shows the assistance profile of the apparatus 300, 600. The horizontal axis 1171 is knee angle (in units of degrees). The graph 1170 represents the phantom knee angle and exoskeleton moment independent of time. Note the similarity of this graph 1170 to the graph 100 of FIG. 1B. The exoskeleton apparatus 300, 600 behaves like a torsional spring during stance movement phase 152, providing a knee extensor moment proportional to the change in knee flexion angle. In an example embodiment, the exoskeleton apparatus 300, 600 provides 47.3 Nm/rad of knee extension moment during stance movement phase 152.

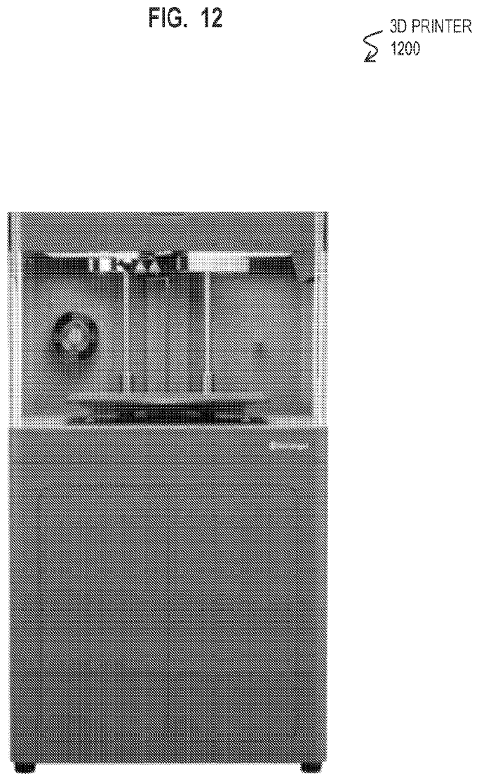

A system that can be used to 3D print one or more components of the apparatus 200, 200′, 300, 600 is now discussed. FIG. 12 is an image illustrating an example of a 3D printer 1200 used to form one or more components of the apparatus 300 of FIG. 3A or the apparatus 600 of FIG. 6A, according to an embodiment. Although one example embodiment of the 3D printer 1200 is depicted in FIG. 12, the embodiments of the present invention is not limited to this 3D printer 1200 and includes any 3D printer that is capable of forming the components of the apparatus 300, 600, according to the specifications discussed herein. In an example embodiment, the 3D printer 1200 is a Markforged X7® 3D printer. In an example embodiment, each of the upper bar 302, the lower bar 304, clutch lever 321 or 321′, the clutch sprocket 322, the cable fixation 350a, 350b, the shoe lever 400 or 400′ and/or the knee sprocket 330 are 3D printed by the 3D printer 1200. In some embodiments, the cable fixation 350 is printed separately from the upper bar 302 (e.g. prototyping purposes). In other embodiments, the cable fixation 350a and the upper bar 302 are integrally printed as one unit. In an example embodiment, the apparatus 300, 600 with the 3D printer components has a total weight (for each leg) of less than 3 kg. In a more specific embodiment, the total weight (for each leg) is less than 2 kg. In a more specific embodiment, the total weight (for each leg) is about 1 kg. In still other embodiments, the one or more components of the apparatus 300, 600 are 3D printed using one or more of carbon fiber, nylon and Kevlar material.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. An apparatus comprising:
a first bar configured to be attached to a thigh above a knee joint of a subject;
a second bar configured to be attached to a shank below the knee joint and pivotally coupled to the first bar adjacent the knee joint;
a spring attached to the first bar and connected to a spring pulley;
a sprocket configured to rotate based on variation of an angle between the first bar and the second bar during a gait cycle of the subject; and
a clutch configured to:
rotatably connect the sprocket with the spring pulley during a stance movement phase of the gait cycle such that rotation of the sprocket causes rotation of the spring pulley and elongation of the spring to impart an assistive extensor moment about the knee joint, and
rotatably disconnect the sprocket with the spring pulley during a swing movement phase of the gait cycle such that rotation of the sprocket does not cause rotation of the spring pulley and elongation of the spring;
wherein at least one of:
the apparatus excludes electrical components that transmit or receive electrical signals; and
the apparatus has a total weight of less than about 3 kg for each leg of the subject.

2. The apparatus of claim 1, wherein the apparatus excludes electrical components that transmit or receive electrical signals and only includes mechanical components that do not transmit or receive electrical signals.

3. The apparatus of claim 1, wherein the apparatus has a total weight of less than about 2 kg for each leg of the subject.

4. The apparatus of claim 1, wherein the assistive extensor moment is linearly proportional to a knee angle during the stance movement phase between the thigh and the shank.

5. The apparatus of claim 1, wherein a knee extensor moment stiffness of the knee joint due to the assistive extensor moment is based on a linear stiffness of the spring, sprocket teeth ratio, and a radius of the spring pulley.

6. The apparatus of claim 1, wherein the second bar is pivotally coupled to the first bar at a knee sprocket that is configured to be positioned adjacent the knee joint; and
wherein the sprocket is a clutch sprocket attached to the first bar and wherein the knee sprocket is pivotally coupled to the clutch sprocket such that rotation of the knee sprocket during the gait cycle causes rotation of the clutch sprocket.

7. The apparatus of claim 6, wherein the knee sprocket and clutch sprocket are connected by a chain.

8. The apparatus of claim 1, wherein the clutch comprises a clutch lever configured to move to a first position during the stance movement phase of the gait cycle and wherein the clutch lever is configured to rotatably connect the sprocket with the spring pulley in the first position; and
wherein the clutch lever is configured to move to a second position during the swing movement phase and wherein the clutch is configured to not rotatably connect the sprocket with the spring pulley in the second position

9. The apparatus of claim 8,
wherein the sprocket and the spring pulley each comprise interfacing teeth;
wherein the sprocket and the spring pulley are mounted to a clutch pin;
wherein the clutch lever is configured to move the sprocket along the clutch pin towards the spring pulley when the clutch lever is moved to the first position such that the interfacing teeth of the sprocket rotatably engage the interfacing teeth of the spring pulley during the stance movement phase.

10. The apparatus of claim 9, further comprising compression springs positioned between the spring pulley and the sprocket;
wherein the compression springs are configured to separate the sprocket and the spring pulley when the clutch lever is moved to the second position such that the interfacing teeth of the sprocket do not rotatably engage the interfacing teeth of the spring pulley during the swing movement phase

11. The apparatus of claim 8, wherein the clutch lever has a first end with an extension configured to be received within one of a plurality of openings in the first bar when the clutch lever is moved to the second position; and
wherein the clutch lever has a second end opposite to the first end such that the second end is configured to move the interfacing teeth of the sprocket to rotatably connect with the interfacing teeth of the spring pulley when the clutch lever is moved to the first position.

12. The apparatus of claim 8, further comprising a shoe lever configured to be coupled to a shoe during the gait cycle;
wherein a first end of a cable is configured to be attached to the clutch lever and a second end of the cable is configured to be configured to be attached to the shoe lever;
wherein the shoe lever is configured to move to a first position during the stance movement and to a second position during the swing movement phase
wherein the cable is configured to move the clutch lever to the first position based on the shoe lever moving to the first position and wherein the cable is configured to move the clutch lever to the second position based on the shoe lever moving to the second position.

13. The apparatus of claim 12, wherein the shoe lever comprises:
a ramp portion coupled to the second end of the cable and pivotally coupled to a base portion configured to be positioned within the shoe;
wherein the ramp portion is configured to move towards the base portion when the shoe lever is moved to the first position such that the cable is configured to move the clutch lever to the first position.

14. The apparatus of claim 13, wherein the cable attachment is configured to be positioned outside the shoe and is integral with the ramp portion that is configured to be positioned within the shoe.

15. The apparatus of claim 12, wherein the shoe lever comprises:
a ramp portion coupled to the second end of the cable and pivotally coupled to a base portion configured to be positioned outside the shoe;
wherein the ramp portion is configured to move towards the base portion when the shoe lever is moved to the first position such that the cable is configured to move the clutch lever to the first position.

16. The apparatus of claim 12, wherein the shoe lever is rotatably coupled to the apparatus with a plurality of joints which facilitate rotation of the shoe relative to the apparatus about multiple axes and provide multiple degrees of freedom of the shoe relative to the apparatus.

17. The apparatus of claim 12, further comprising the cable including an outer tube and an inner cable;
wherein the shoe lever comprises an outer tube attachment and an inner cable attachment configured to be mounted outside the shoe to a heel of the shoe;
wherein the outer tube of the cable at the second end is configured to attach to the outer tube attachment;
wherein the inner cable of the cable at the second end is configured to attach to the inner cable attachment such that only the inner cable extends from the outer tube attachment to the inner cable attachment; and
wherein the shoe lever being configured to move to the first position comprises the inner cable attachment and the attached inner cable moving to the first position during the stance movement phase.

18. The apparatus of claim 1, wherein the spring is a linear spring that is configured such that the assistive extensor moment imparted about the knee joint varies linearly with the angle between the first bar and the second bar during the stance movement phase.

19. The apparatus of claim 1, wherein the second bar comprises a joint configured to act as a hinge between a first portion of the second bar and a second portion of the second bar to permit alignment of the first portion and the second portion of the second bar with the shank of the subject below the knee.

20. The apparatus of claim 1, wherein the first bar and the second bar each define a plurality of openings and one or more strap attachments are connected to one or more of the plurality of openings of the first bar and the second bar and wherein the one or more strap attachments are configured to receive one or more respective straps to secure the first bar to the thigh of the subject and the second bar to the shank of the subject.

21. The apparatus of claim 1, wherein the first bar and the second bar each define a plurality of openings and one or more collars are connected to one or more of the plurality of openings of the first bar and the second bar, wherein the one or more collars have a diameter that is larger than an outer diameter of the thigh and shank to receive the thigh and shank and wherein the diameter of the one or more collars is adjustable to secure the one or more collars around the thigh and shank.

22. The apparatus of claim 1, wherein one or more components of the apparatus are 3D printed.

23. The apparatus of claim 22 wherein the first bar, the second bar and the sprocket are 3D printed and wherein the apparatus has the total weight of less than about 3 kg.

24. The apparatus of claim 22, wherein the one or more components are 3D printed with one of carbon fiber, nylon and Kevlar material.

25. The apparatus of claim 12, wherein the shoe lever is 3D printed with one of carbon fiber, nylon and Kevlar material.

26. A method comprising:
attaching a first bar to a thigh above a knee joint of a subject;
attaching a second bar to a shank below the knee joint, wherein the second bar is pivotally coupled to the first bar adjacent the knee joint;
varying an angle between the first bar and the second bar during a gait cycle of the subject;
rotating a sprocket based on the varying of the angle during the gait cycle;
wherein during a stance movement phase of the gait cycle;
rotatably connecting, with a clutch, the sprocket with a spring pulley attached to a spring,
rotating the spring pulley based on the rotatable connection between the sprocket and the spring pulley,
elongating the spring based on the rotation of the spring pulley, and
imparting an assistive extensor moment about the knee joint based on the elongation of the spring,
wherein during a swing movement phase of the gait cycle;
rotatable disconnecting, with the clutch, the sprocket with the spring pulley such that an assistive extensor moment is not imparted about the knee joint;
and wherein the method excludes transmitting or receiving electrical components.

27. A method comprising 3D printing one or more components of the apparatus of claim 1.

28. The method of claim 27 comprising 3D printing the first bar, the second bar and the sprocket and wherein the apparatus has the total weight of less than 3 kg.

29. The method of claim 27, wherein the one or more components are 3D printed with one of carbon fiber, nylon and Kevlar material.

30. A method comprising 3D printing the shoe lever of the apparatus of claim 12, wherein the shoe lever is 3D printed with one of carbon fiber, nylon and Kevlar material.
